(19) United States
(12) Patent Application Publication
(10) Pub. No.: US 2005/0144478 A1
(43) Pub. Date: Jun. 30, 2005

(54) Content receiving/storing apparatus and content delivery system

(75) Inventors: Taichiro Yamanaka, Hachioji-shi (JP); Noriyo Fujii, Ome-shi (JP); Kazunori Demachi, Ome-shi (JP); Yutaka Ueno, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/956,047

(22) Filed: Oct. 4, 2004

(30) Foreign Application Priority Data
Dec. 25, 2003 (JP) 2003-428505

(51) Int. Cl. H04L 9/00

(52) U.S. Cl. 713/201

(57) ABSTRACT

Encrypted content, an encrypted content key and an encryption key are generated. The encrypted content and the encrypted content key are delivered to a local server via a network and are stored. A decryption key for decrypting the encrypted content key that corresponds to a reproduction request for predetermined content, and the encryption key for re-encrypting the decrypted content key that is decrypted by the decryption key are delivered via the network. Thereby, the encrypted content is decrypted using the decrypted content key. The decrypted content key is re-encrypted using the encryption key, and the stored encrypted content key is updated with the re-encrypted content key, and the updated content key is stored.

### CROSS-REFERENCE TO RELATED APPLICATIONS

This application is based upon and claims the benefit of priority from prior Japanese Patent Application No. 2003-428505, filed Dec. 25, 2003, the entire contents of which are incorporated herein by reference.

### BACKGROUND OF THE INVENTION

1. Field of the Invention

The present invention relates generally to a technique for delivering content via a network, and more particularly to a content receiving/storing apparatus and a content delivery system with an enhanced security function in encrypted-content delivery.

2. Description of the Related Art

Content and valid-term expiration date information, which is delivered from a content delivery server, is directly sent to a user device. In the user device to which such content and information is sent, a disposable key is generated each time the content is used and the content is re-encrypted, thereby to protect the copyright of the content (see, e.g. Jpn. Pat. Appln. KOKAI Publication No. 2002-44071 (Patent Document 1).

In this structure, however, since the key is generated in the user apparatus, content whose valid term of use has already expired may possibly be reproduced. Thus, it is difficult to maintain the security.

### BRIEF SUMMARY OF THE INVENTION

The present invention has been made in consideration of the above circumstances, and the object of the invention is to provide a content receiving/storing apparatus and a content delivery system with an enhanced security function, wherein content, the valid term of use of which has already expired, cannot be reproduced.

According to an aspect of the present invention, there is provided a content delivery system comprising: first encryption means for generating a content key for encrypting selected content to generate encrypted content, and decrypting the encrypted content; second encryption means for generating a first encryption key for encrypting the content key to generate an encrypted content key; first delivery means for delivering via a network the encrypted content that is encrypted by the first encryption means and the encrypted content key that is encrypted by the second encryption means; storage means for storing the encrypted content and the encrypted content key that are delivered by the first delivery means; second delivery means for generating, upon receiving a reproduction request for reproducing predetermined content, a first decryption key for decrypting the encrypted content key corresponding to the predetermined content, the reproduction request for which is received, and a second encryption key for re-encrypting the decrypted content key that is decrypted by the first decryption key, and delivering the first decryption key and the second encryption key via the network; first decryption means for decrypting the encrypted content key using the first decryption key that is delivered by the second delivery means; second decryption means for decrypting the encrypted content using the decrypted content key that is decrypted by the first decryption means; re-encryption means for re-encrypting, with use of the second encryption key, the decrypted content key that is decrypted by the first decryption means; and updating means for updating the encrypted content key that is stored in the storage means with the encrypted content key that is re-encrypted by the re-encryption means, and storing the updated encrypted content key in the storage means.

Accordingly, in the present invention, a content key for encrypting selected content to generate encrypted content and decrypting the encrypted content is generated. A first encryption key for encrypting the content key to generate an encrypted content key is generated. The encrypted content and the encrypted content key are delivered via a network and are stored. Upon reception of a reproduction request for reproducing predetermined content, a first decryption key for decrypting the encrypted content key corresponding to the predetermined content, the reproduction request for which is received, and a second encryption key for re-encrypting the decrypted content key, which is decrypted by the first decryption key, are delivered via the network. The encrypted content key is decrypted using the first decryption key that is delivered. The encrypted content is decrypted using the decrypted content key. With use of the second encryption key, the decrypted content key is re-encrypted, and the stored encrypted content key is updated with the encrypted content key that is re-encrypted, and the updated encrypted content key is stored. Therefore, the invention can provide a content receiving/storing apparatus and a content delivery system with an enhanced security function, wherein there is no fear that content, the effective term of which has expired, is reproduced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram that shows the configuration of a content delivery system to which a content delivery apparatus according to a first embodiment of the present invention is applied;

FIG. 2 is a block diagram that shows a content delivery server, which is the content delivery apparatus according to the first embodiment of the invention;

FIG. 3 is a block diagram that shows the data structure of content license information relating to the first embodiment of the invention;

FIG. 4 is a block diagram that shows a local server according to the first embodiment of the invention;

FIG. 5 is a block diagram that shows a user terminal, which is connectable to a LAN according to the first embodiment of the invention;

FIG. 6 is a flow chart that illustrates an outline of a content reproduction process according to the first embodiment of the invention;

FIG. 7 is a flow chart that specifically illustrates a user authentication process in step S502 in the first embodiment of the invention;

FIG. 8 is a flow chart that illustrates a content license confirmation process in the content delivery system, to which the content delivery apparatus according to the first embodiment of the invention is applied;

FIG. 9 is a flow chart that illustrates a content acquisition process in which the local server acquires content from the content delivery server, with the application of the content delivery apparatus according to the first embodiment of the invention;

FIG. 10 is a flow chart that illustrates a content key re-encryption process in the content delivery system, to which the content delivery apparatus according to the first embodiment of the invention is applied;

FIG. 11 is a sequence diagram corresponding to FIG. 10 according to the first embodiment of the present invention;

FIG. 12 is a flow chart that illustrates a content license suspension process, which is executed by a user terminal according to the first embodiment of the invention;

FIG. 13 is a sequence diagram corresponding to FIG. 12 according to the first embodiment of the invention;

FIG. 14 is a flow chart that illustrates a content license suspension process, which is executed by a content provider according to the first embodiment of the invention;

FIG. 15 is a sequence diagram corresponding to FIG. 14 according to the first embodiment of the invention;

FIG. 16 is a diagram showing content license information according to a second embodiment of the invention; and

FIG. 17 is a flow chart that illustrates a content license suspension process, which is executed by the user according to the second embodiment of the invention.

### DETAILED DESCRIPTION OF THE INVENTION

Embodiments of the present invention will now be described with reference to the accompanying drawings.

### First Embodiment

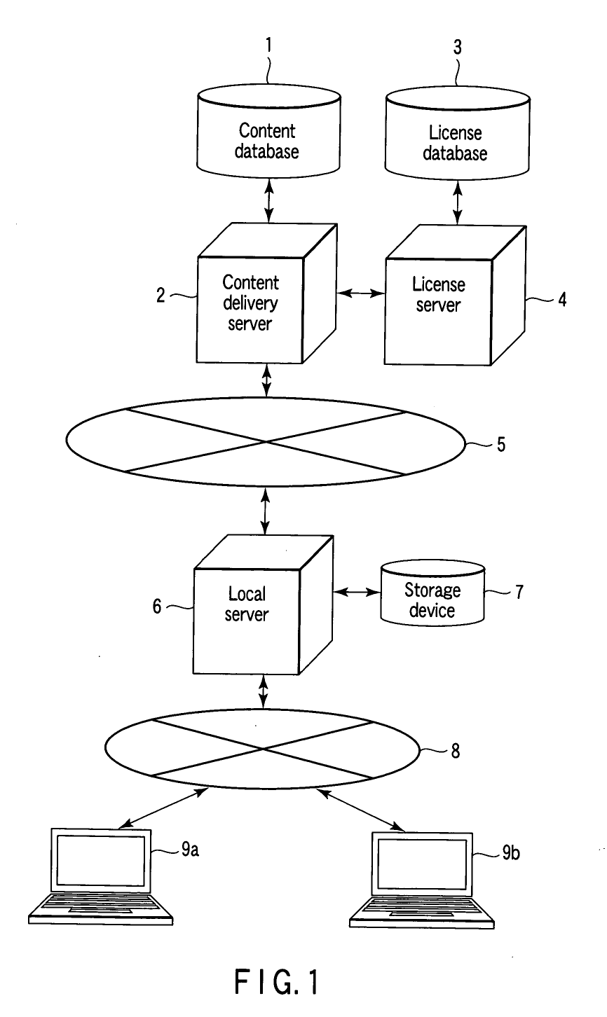

FIG. 1 is a block diagram that shows the configuration of a content delivery system to which a content delivery apparatus according to a first embodiment of the present invention is applied.

The content delivery system according to the embodiment comprises: a content delivery server 2 that is connected to a network 5 such as a WAN (Wide Area Network) or the Internet; a content database 1 and a license server 4, which are connected to the content delivery server 2; a license database 3 that is connected to the license server 4; a local server 6 that is connectable to the content delivery server 2 via the network 5; a storage device 7 that is connected to the local server 6; and a user terminal 9a and a user terminal 9b, which are connectable to the local server (content receiving/storing apparatus) 6 via a LAN (Local Area Network) 8.

FIG. 1 is a conceptual diagram. The content database 1 may be incorporated in the content delivery server 2. The license database 3 may be accommodated in the license server 4. The content delivery server 2 and license server 4 may be integrally constructed.

The content database 1 is constructed on a large-capacity storage device such as a hard disk drive or an optical disk drive. The content database stores a plurality of contents for delivery to a plurality of user terminals such as the user terminals 9a and 9b. The “content” in this embodiment is representative of, for instance, still images, motion video, voices, characters, programs, and combinations thereof.

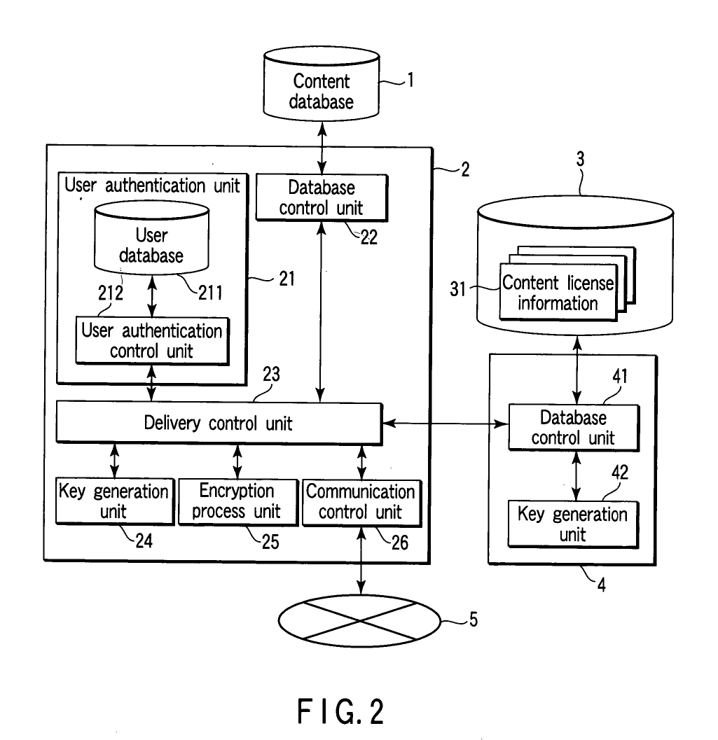

As is shown in FIG. 2, the content delivery server 2 comprises a user authentication unit 21 that executes authentication with the user terminal 9a, 9b; a database control unit 22 that executes a control such as transmission/reception of data with the content database 1; a delivery control unit 23 that executes data relay and controls data delivery; a key generation unit 24 that generates key information such as a content key (to be described later); an encryption process unit 25 that executes data encryption/decryption; and a communication control unit 26 that executes, e.g. a control of communication with the network 5.

The authentication unit 21 includes a user database 211 and a user authentication control unit 212. The user database 211 stores at least, as identification (ID) information, a user ID that identifies a user and a password associated with the user ID. The user authentication control unit 212 collates user authentication information, which is sent from the local server 6, with user information that is registered in the user database 211. A password authentication system, for instance, is used as a user authentication system. Other authentication systems, however, may be used. In addition, the user authentication unit 21 executes operations for registration and deletion of user information. In the embodiment of the invention, the user authentication unit 21 is configured on the hard disk drive. Alternatively, the user authentication unit 21 may be configured on a writable/readable nonvolatile memory medium such as a RAM.

The database control unit 22 executes operations for registration, search and deletion of data in the content database 1.

The delivery control unit 23 issues instruction information to the user authentication unit 21, database control unit 22, key generation unit 24, encryption process unit 25, communication control unit 26 and license server 4 in order to execute a series processes: user authentication with the local server 6 (to be described later), delivery of content information to the local server 6, confirmation and update of the user's content license (i.e. user's right to use content), encryption of content and a key for encrypting content (hereinafter referred to as “content key”), and delivery of key information.

The key generation unit 24 generates the aforementioned content key in consideration of a possible infringement on copyright, such as unauthorized alteration (tampering) or duplication. A common-key encryption system, in which the same key is used for encryption and decryption, is used as a content key encryption system. Alternatively, a public-key encryption system, in which different keys are used for encryption and decryption, may be used.

The encryption process unit 25 encrypts content using the content key that is generated by the key generation unit 24.

The communication control unit 26 executes a control to perform communication with the local server 6, which is connected via the network 5, on the basis of a predetermined protocol. In this embodiment, TCP/IP is used as the protocol for communication over the network 5. Alternatively, other communication protocols may be used.

The license server 4 includes a database control unit 41 that controls, e.g. transmission/reception of data with the license database 3, and a key generation unit 42. The license database 3 stores content license information 31. The license database 3 is constructed on a large-capacity storage device such as a hard disk drive or an optical disk drive. The database control unit 41 executes operations for registration, search and deletion of data in the license database 3. The key generation unit 42 generates a key that is used for encryption/decryption of the content key. The encryption/decryption of the content key is described later in detail. The key that is generated by the key generation unit 42 is based on the public-key encryption system.

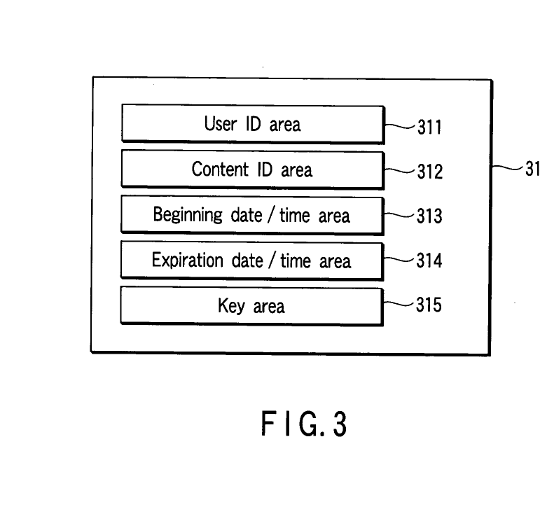

FIG. 3 is a block diagram that shows the data structure of the content license information 31.

The content license information 31 that is stored in the license database 3 is produced in association with each of content IDs and each of content IDs that are used to identify contents.

The content license information 31 includes a user ID area 311 that stores a user ID; a content ID area that stores a content ID; a beginning date/time area 313 that stores a beginning date/time of the valid term of the content license; an expiration date/time area 314 that stores an expiration date/time; and a key area 315 that stores a key for decrypting an encrypted content key (to be described later). The content license information is composed of, e.g. a user ID, a content ID for identifying content, and valid-term information of a content license.

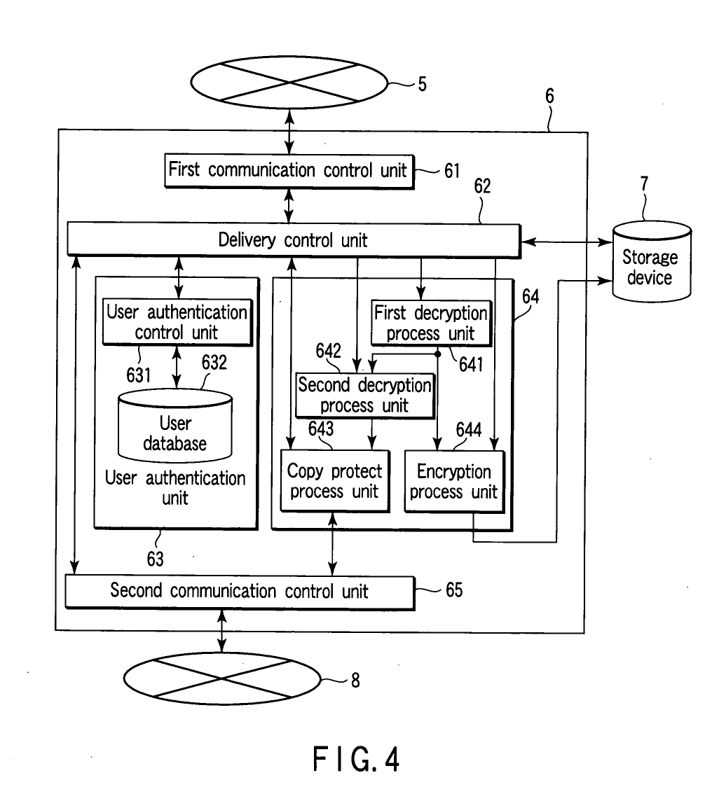

As is shown in FIG. 4, the local server 6 is connected to the content delivery server 2 via the network 5. The local server 6 comprises a first communication control unit 61, a delivery control unit 62, a user authentication unit 63, a module 64 and a second communication control unit 65.

The first communication control unit 61 executes a control for communication with the content delivery server 2 on the basis of the TCP/IP protocol.

The delivery control unit 62 is a module that issues instructions to the first communication control unit 61, user authentication unit 63, module 64, second communication control unit 65 and storage device 7 in order to execute a series of processes: user authentication with the user terminal (to be described later), content delivery, requests to the content delivery server 2 such as a request for delivery of a key for decryption, encryption/decryption, and storage of content in the storage device 7.

The user authentication unit 63 includes a user authentication control unit 631 and a user database 632.

The user authentication control unit 631 collates user authentication information, which is sent from the user terminal 9a or user terminal 9b, with user information that is registered in the user database 632. Thus, the user authentication control unit 631 executes user authentication. In this embodiment, a password authentication system, for instance, is used as a user authentication system. Other authentication systems, however, may be used.

The user database 632 stores, as information, at least a user ID that identifies a user and a password associated with the user ID. In the embodiment of the invention, the user authentication unit 63 is configured on the hard disk drive. Alternatively, the user authentication unit 63 may be configured on a writable/readable nonvolatile memory medium such as a RAM.

The module 64 has an anti-tampering function, and comprises a first decryption process unit 641, a second decryption process unit 642, a copy protect process unit 643 and an encryption process unit 644.

The first decryption process unit 641 decrypts an encrypted content key, which is delivered from the content delivery server 2, by using a private key that is acquired from the content delivery server 2.

The second decryption process unit 642 decrypts encrypted content, using the content key that is decrypted by the first decryption process unit 641.

The copy protect process unit 643 is a module that executes a copy protect process for copyright protection, when the content that is decrypted by the second decryption process unit 642 is delivered to the user terminal. In this embodiment of the invention, DTCP (Digital Transmission Content Protection) is used as a copy protection system. Alternatively, other protection systems may be used. The DTCP is a standard in which data is encrypted and transmitted between devices that are connected over an IEEE 1394 bus.

The encryption process unit 644 encrypts the content key, which is decrypted by the first decryption process unit 641, by using a new public key that is acquired from the content delivery server 2.

The second communication control unit 65 executes a control for communication with the user terminal 9a or user terminal 9b that is connected via the LAN 8. As mentioned above, IEEE 1394 is used for the communication, but other standards may be used. In the embodiment of the invention, two user terminals, i.e. user terminals 9a and 9b, are used, but more user terminals may be used. Although there is a limit number of connectable user terminals on the IEEE 1394 standard, the number of connectable user terminals is, needless to say, not limited in the present invention.

The storage device 7 is a large-capacity storage apparatus such as a hard disk drive or an optical disk drive. The storage device stores encrypted content and encrypted content keys. The user terminal 9a and user terminal 9b are terminals of users who use content. Specifically, the user terminal 9a, 9b is a personal computer, a mobile information terminal, or a TV receiver.

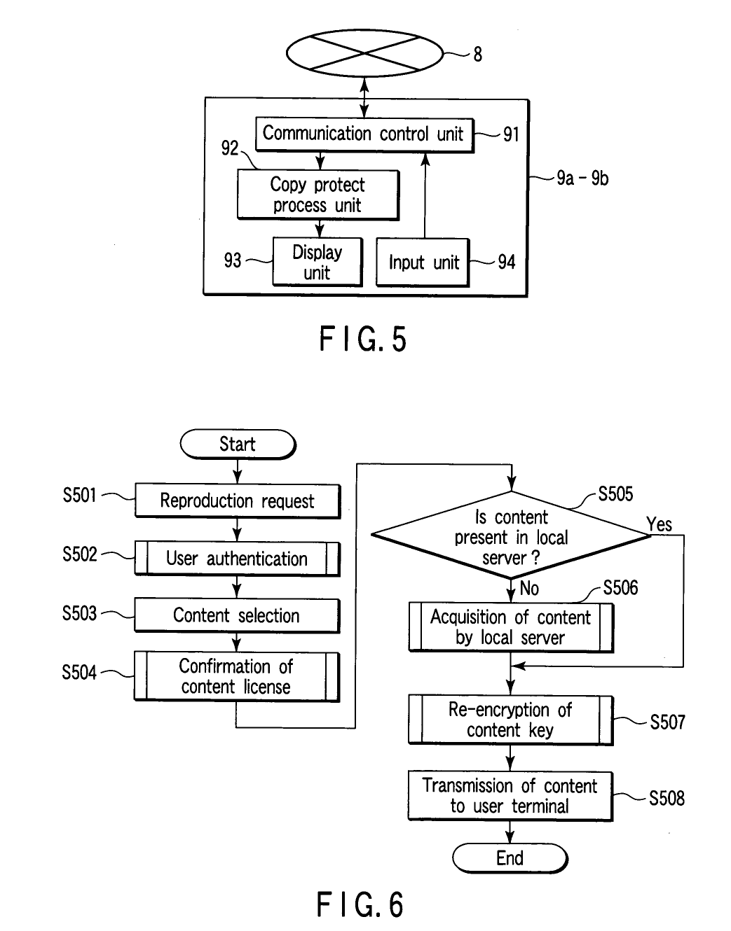

As is shown in FIG. 5, the user terminal 9a, 9b includes a communication control unit 91 that executes a series of processes including at least user authentication and a content delivery request; a copy protect process unit 92 that executes a decryption process for copy-protected content that is delivered from the local server 6; a display unit 93 that reproduces or displays content that is requested; and an input unit 94 that inputs, e.g. a user ID and a password at a time of user authentication, and a request for content delivery.

Next, referring to FIG. 6 to FIG. 15, a description is given of the operation of the content delivery system to which the content delivery apparatus according to the first embodiment of the invention is applied.

To begin with, the operation of the system at a time of content reproduction is described. Now assume that the user database 211 and user database 632 store a user ID and an associated user password, which are to be processed, and that content license information is already stored in the license database 3. Also assume that the user uses the user terminal 9a.

As regards the collation of two user authentication information items, “success” in collation is defined as a case where both the user ID and password are coincident between the two user authentication information items, and “failure” in collation is defined as a case where both the user ID and password are not coincident between the two user authentication information items. In addition, “user authentication” with use of user authentication information A and database B is defined as collation between the user authentication information A and each user authentication information stored in the database B. Besides, “success” in user authentication with use of user authentication information A and database B is defined as a case where user authentication information that is successfully collated with the user authentication A is present in the database B, and “failure” in user authentication with use of user authentication information A and database B is defined as a case where user authentication information that is successfully collated with the user authentication A is not present in the database B.

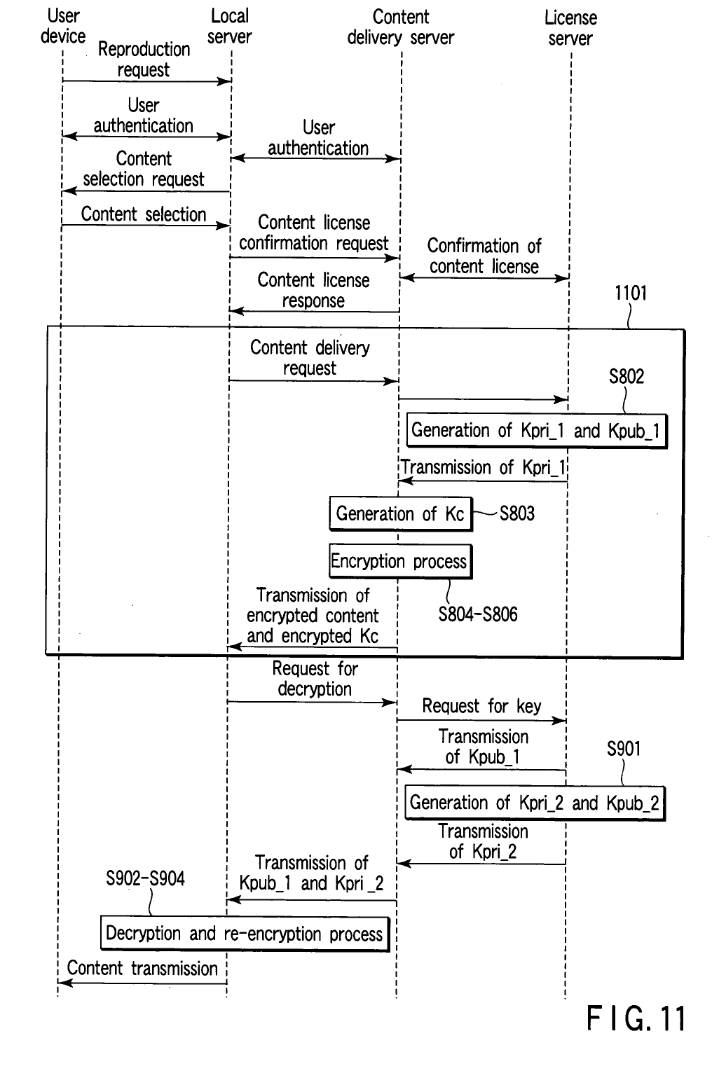

FIG. 6 is a flow chart that illustrates an outline of a content reproduction process according to the first embodiment of the invention. FIG. 11 is a sequence diagram corresponding to the flow chart of FIG. 6 (a process in area 1101 in the sequence diagram corresponds to step S506 in FIG. 6, and this process is not executed in a case where content to be reproduced is present in the local server). Unless otherwise specified, communication between the content delivery server 2 and local server 6 is executed via the communication control unit 26 of the content delivery server 2, the network 5 and the first communication control unit 61 of the local server 6. In addition, communication between the user terminal 9a and local server 6 is executed via the second communication control unit 65, LAN 8 and the communication control unit 91. It is preferable that all communications that are executed in the embodiment of the invention be encrypted.

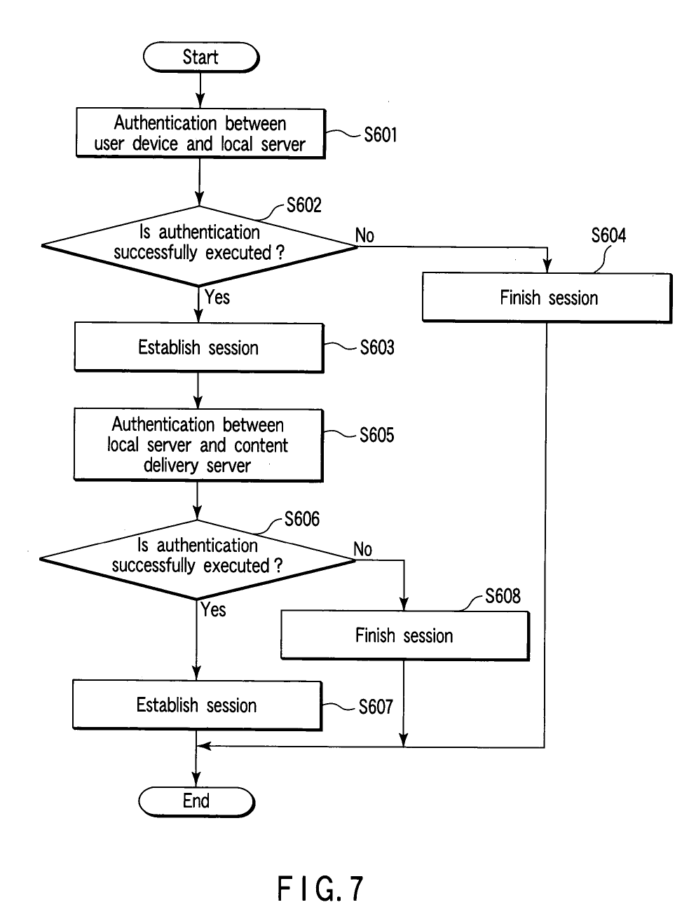

To start with, a content reproduction request is issued from the input unit 94 of user terminal 9a to the local server 6 (step S501). Then, in step S502, a user authentication process is executed. FIG. 7 specifically illustrates the user authentication process in step S502.

If the delivery control unit 62 of the local server 6 receives the content reproduction request, the delivery control unit 62 requests user authentication information comprising a user ID and a password from the user terminal 9a. Upon receiving the request for the user authentication information, the user terminal 9a transmits via the input unit 94 the user authentication information comprising the user ID and password to the local server 6. Receiving the user authentication information from the user terminal 9a, the delivery control unit 62 of local server 6 executes user authentication with use of the user authentication information and the user database 632 (step S601) and determines whether the authentication is successfully completed (step S602). If the user authentication is successful, the delivery control unit 62 transmits the user authentication information to the content delivery server 2 via the first communication control unit 61 and network 5, and then establishes a session with the user terminal 9a (step S603). If the user authentication fails, the delivery control unit 62 informs the user terminal 9a of the failure in user authentication and finishes the session (step S604).

If the delivery control unit 23 of content delivery server 2 receives the user authentication information from the local server 6, the delivery control unit 23 executes user authentication with use of the user authentication information and user database 211 (step S605) and determines whether the authentication is successfully completed (step S606). If the user authentication is successful, the content delivery server 2 informs the local server 6 of the success in user authentication and establishes a session with the local server 6.

In this case, the user ID is retained in the delivery control unit 23 (step S607). If the user authentication fails, the content delivery server 2 informs the local server 6 of the failure in user authentication and finishes the session between the content delivery server 2 and local server 6, and also the local server 6 informs the user terminal 9a of the failure in user authentication and finishes the session between the local server 6 and user terminal 9a (step S608). The user authentication process is thus completed. In the embodiment of the invention, the above-described user authentication system is employed, but the invention is not limited to this user authentication system.

Next, referring back to FIG. 6, a content reproduction process (step S503 and the following steps in FIG. 6) is described. Upon receiving the information on the success in user authentication from the content delivery server 2, the delivery control unit 62 of local server 6 requests a content ID for identifying to-be-reproduced content from the user terminal 9a. Upon receiving the request for the content ID, the user terminal 9a inputs the content ID of the to-be-reproduced content via the input unit 94 and sends the content ID to the local server 6 (step S503). Subsequently, in step S504, a content license confirmation process is executed. The details of this process are as follows.

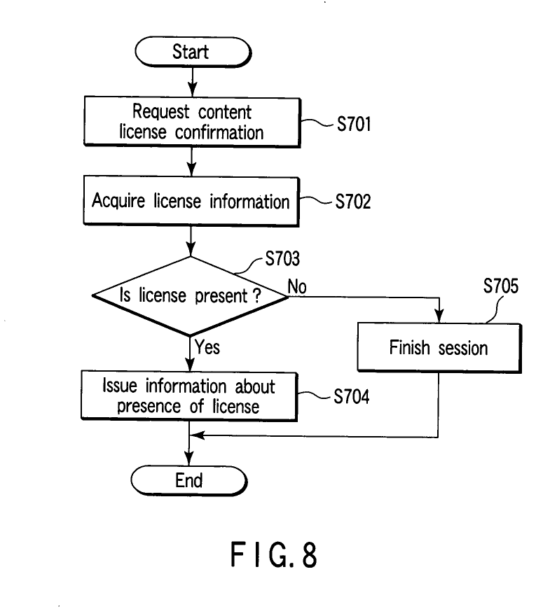

FIG. 8 is a flow chart that illustrates the content license confirmation process in the content delivery system, to which the content delivery apparatus according to the first embodiment of the invention is applied.

Upon receiving the content ID of the to-be-reproduced content from the user terminal 9a, the delivery control unit 62 of local server 6 transmits a content license confirmation request, along with the content ID, to the content delivery server 2, thereby to confirm whether the user who is identified by the user ID has a license for using the content that is identified by the content ID (step S701). If the delivery control unit 23 of content delivery server 2 receives the content license confirmation request from the local server 6, the delivery control unit 23 searches the license database 3 via the database control unit 41 of license server 4 using, as a key, the pair of the user ID that is retained by the delivery control unit 23 and the content ID that is added to the content license confirmation request. Thus, the delivery control unit 23 acquires the content license information 31 corresponding to the key (step S702).

The delivery control unit 23 determines the presence/absence of the license on the basis of the acquired content license information 31 (step S703). If the delivery control unit 23 determines in step S703 that the license is present, the delivery control unit 23 sends to the local server 6 a response indicative of the presence of the license. At this time, the content ID is retained in the delivery control unit 23 (step S704). If the delivery control unit 23 determines in step S703 that the license is absent, the delivery control unit 23 sends to the local server 6 a response indicative of the absence of the license and finishes the session between the content delivery server 2 and local server 6, and also the local server 6 informs the user terminal 9a of the absence of the license and finishes the session between the local server 6 and user terminal 9a (step S705).

The content license confirmation process is thus completed. Referring back to FIG. 6, the content reproduction process is further described. If the delivery control unit 62 of local server 6 receives the information on the presence of the license from the content delivery server 2, the delivery control unit 62 determines whether the content that is identified by the content ID is stored in the storage device 7 (step S505). If the content is not stored, the delivery control unit 62 acquires the content from the content delivery server 2 (step S506) and goes to step S507. If the content is stored, the delivery control unit 62 goes to step S507 without acquiring the content from the content delivery server 2. The details of the content acquisition process for acquiring content from the content delivery server 2 are as follows.

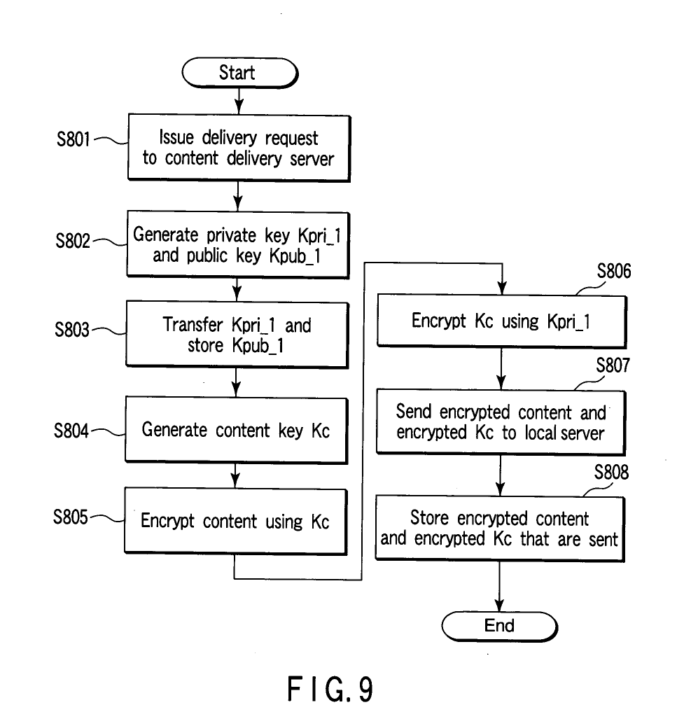

FIG. 9 is a flow chart that illustrates the content acquisition process in which the local server 6 acquires content from the content delivery server 2, with the application of the content delivery apparatus according to the first embodiment of the invention.

The delivery control unit 62 of local server 6 sends to the content delivery server 2 a request for delivery of the content that is identified by the content ID (step S801). If the delivery control unit 23 of content delivery server 2 receives the content delivery request from the local server 6, the content delivery server 2 instructs the license server 4 to generate a private key (hereinafter referred to also as “Kpri_1”) and a public key (“Kpub_1). Upon receiving the instruction, the key generation unit 42 of the license server 4 generates the Kpri_1 and Kpub_1 (step S802).

The generated Kpri_1 is transferred to the delivery control unit 23. The generated Kpub_1 is stored in the key area 315 of the content license information 31 that is acquired by searching the license database 3 using, as a key, the pair of the user ID and content ID. Thereby, the license database 3 is updated (step S803). The delivery control unit 23 of content deliver server 2, which has acquired the Kpri_1 from the key generation unit 42, instructs the key generation unit 24 to generate a content key (hereafter referred to also as “Kc”), and acquires the Kc from the key generation unit 24 (step S804).

Next, the delivery control unit 23 instructs the database control unit 22 to search the content database 1 using the content ID as a key. Thereby, the delivery control unit 23 acquires the content that is identified by the content ID and inputs to the encryption process unit 25 the acquired content as a to-be-encrypted object and the content key Kc as a key for encryption. The delivery control unit 23 obtains, as an output, the content that is encrypted using the Kc (step S805).

Subsequently, the delivery control unit 23 inputs the content key Kc as a to-be-encrypted object and the Kpri_1 as a key for encryption to the encryption process unit 25. The delivery control unit 23 then obtains, as an output, the encrypted Kc that is encrypted using the Kpri_1 (step S806). The delivery control unit 23 transmits the encrypted content and the encrypted Kc to the local server 6 (step S807). Upon receiving the encrypted content and the encrypted Kc, the delivery control unit 62 of local server 6 stores them in the storage device 7 (step S808). The content acquisition process, by which the local server 6 acquires content from the content delivery server 2, is thus completed.

Referring back to FIG. 6, the content reproduction process is further described. The next process is a content key re-encryption process in step S507. The re-encryption process includes a process for decrypting the encrypted content. The specific procedure of this process is as follows.

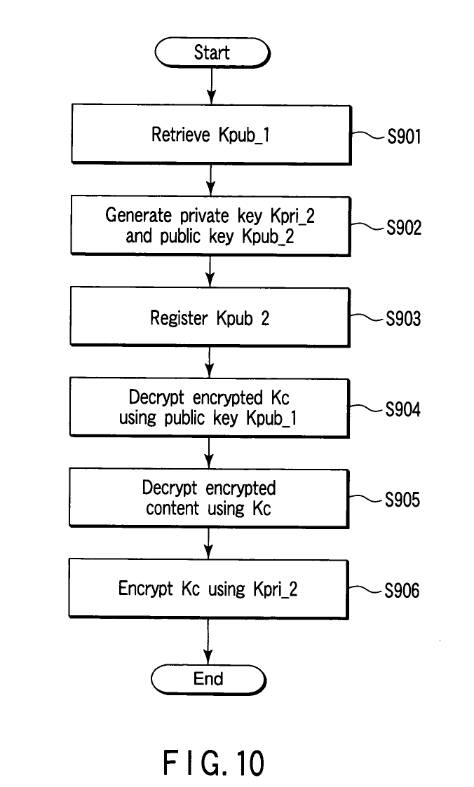

FIG. 10 is a flow chart that illustrates the content key re-encryption process in the content delivery system, to which the content delivery apparatus according to the first embodiment of the invention is applied.

The delivery control unit 62 of local server 6 sends a request for decrypting the encrypted content key Kc to the content delivery server 2. If the delivery control unit 23 receives the request for decrypting the encrypted Kc, the content delivery server 2 instructs the database control unit 41 of license server 4 to retrieve the public key Kpub_1 that is stored in the key area 315 of the content license information 31 in the license database 3. Thus, the content delivery server 2 acquires the Kpub_1 (step S901).

Next, the delivery control unit 23 instructs the license server 4 to generate a new private key (hereinafter referred to also as “Kpri_2”) and a new public key (“Kpub_2”). If the license server 4 receives the instruction, the key generation unit 42 of the license server 4 generates the Kpri_2 and Kpub_2 (step S902). The generated Kpri_2 is transferred to the delivery control unit 23 from the key generation unit 42, and the generated Kpub_2 is stored, in place of the Kpub_1, in the key area 315 of the content license information 31 and is registered in the license database 3 (step S903).

The delivery control unit 23 acquires the Kpub_1 and Kpri_2 and sends them to the local server 6. Upon receiving the Kpub_1 and Kpri_2 from the content delivery server 2, the delivery control unit 62 of local server 6 acquires the encrypted content key Kc and encrypted content from the storage device 7. After the encrypted Kc and encrypted content are acquired, the encrypted Kc is deleted from the storage device 7.

Thereafter, the encrypted Kc, which is a to-be-decrypted object, and the Kpub_1, which is a key for decrypting the encrypted Kc, are input to the first decryption process unit 641, and the encrypted Kc is decrypted using the pubic key Kpub_1 (step S904). The decrypted content key Kc that is obtained by this decryption process is not output to the outside of the module 64 that has the anti-tampering function, and is input to the second decryption process unit 642 and encryption process unit 644.

Thereafter, the encrypted content, which is a to-be-decrypted object, and the Kc, which is a key for decryption, are input to the second decryption process unit 642, and the second decryption process unit 642 decrypts the encrypted content using the decrypted Kc (step S905). Like the decrypted Kc, the content that is obtained by this decryption process is not output to the outside of the module 64 that has the anti-tampering function. The decrypted content key Kc, and the private key Kpri_2, which is a key for re-encrypting the decrypted Kc, are input to the encryption process unit 644. The encryption process unit 644 produces a re-encrypted Kc and this re-encrypted Kc is stored in the storage device 7 (step S906). The content key re-encryption process is thus completed.

Referring back to FIG. 6, the content reproduction process is further described.

The decrypted content that is decrypted by the second decryption process unit 642 is input to the copy protect process unit 643, and a copy protect attribute of, e.g. “Never Copy”, is added to the decrypted content. Thus, a copy prevention process for copy prevention on the user terminal side is executed, and the resultant decrypted content is sent to the user terminal 9a (step S508). If the user terminal 9a receives the content that has been subjected to the copy prevention process in the local server 6, the copy protect process unit 92 executes a decryption process and outputs the decrypted content to the display unit 93. The system operation at the time of content reproduction is thus completed.

Next, a description is given of a system operation in a case where a content license is suspended by the user terminal. Now assume that the user ID that is to be processed and the password corresponding to the user ID are already stored in the user databases 211 and 632, and the content license information is already stored in the license database 3. Also assume that the user uses, e.g. the user terminal 9a. Further, assume that the user authentication in step S502 and the content license confirmation in step S504 are already executed, and that the authentication is successfully completed and the license is present.

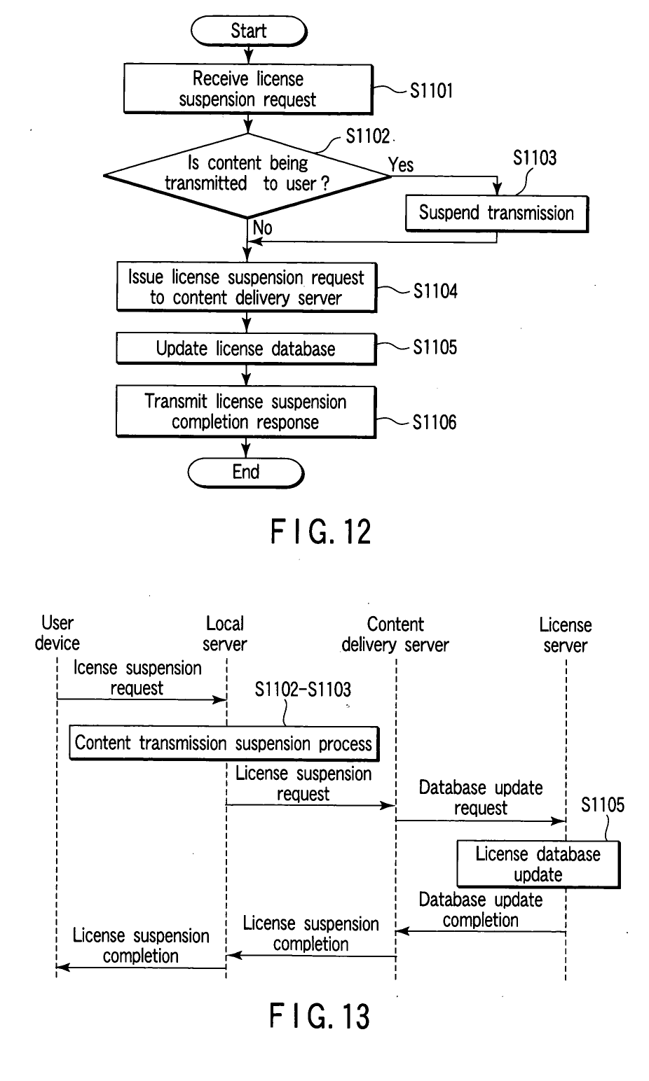

FIG. 12 is a flow chart that illustrates the content license suspension process, which is executed by the user terminal according to the first embodiment of the invention. FIG. 13 is a sequence diagram corresponding to the flow chart of FIG. 12.

To start with, the input unit 94 of the user terminal 9a issues a content license suspension request to the local server 6 (step S1101). The content license suspension request is accompanied with a content ID for identifying content, the license of which is to be suspended. The delivery control unit 62 of the local server 6 determines whether the content is being transmitted to the user terminal 9a (step S1102). If the content is being transmitted, the transmission is suspended (step S1103).

Subsequently, the delivery control unit 62 transmits a license suspension request associated with the present content to the content delivery server 2 (step S1104). This license suspension request is also accompanied with the content ID. Upon receiving the content license suspension request, the delivery control unit 23 of content delivery server 2 instructs the database control unit 41 of license server 4 to execute the following process. The procedure of this process is as follows.

Specifically, the database control unit 41 updates the date/time in the expiration date/time area 314 of the content license information 31 with the current date/time. This content license information 31 is obtained by a search using, as a key, the user ID for identifying the user (the user ID being retained in the delivery control unit 23 at the time of user authentication) and the content ID. Thus, the license database 3 is updated (step S1105), and an update completion response is returned to the delivery control unit 23. Upon receiving the update completion response from the database control unit 41, the delivery control unit 23 sends a content license suspension completion response to the local server 6 (step S1106). Upon receiving the content license suspension completion response from the content delivery server 2, the delivery control unit 62 of local server 6, in turn, sends a content license suspension completion response to the user terminal 9a. Upon receiving the content license suspension completion response from the local server 6, the user terminal 9a displays on the display unit 93 a message to the effect that the content license suspension procedure is completed, thus informing the user of the completion of the procedure. The system operation at the time of content license suspension by the user is thus completed.

As has been described above, finer and more specific operations can be performed by adding information about each content or each user terminal to the content license suspension request.

Next, a description is given of the operation in a case where a content license is suspended by a content provider. The content provider, in this context, refers to a copyright owner of content, a party with a right to provide content, or a party who is entrusted with a content providing business by the copyright owner or the party with the right to provide content. The content provider can directly access the content delivery server 2 without the intervention of the local server 6.

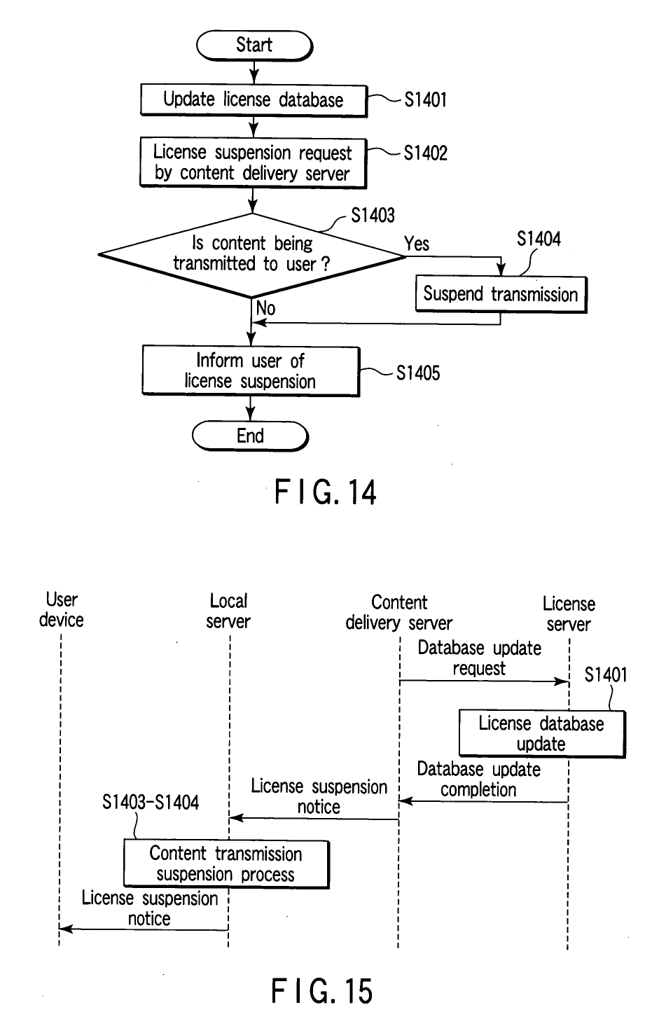

FIG. 14 is a flow chart that illustrates the content license suspension process, which is executed by the content provider according to the first embodiment of the invention. FIG. 15 is a sequence diagram corresponding to the flow chart of FIG. 14.

A terminal (not shown) that is connected to the content delivery server 2 by the content provider designates a user ID and a content ID and issues to the content delivery server 2 a content license suspension request in association with the designated user ID and content ID. Upon receiving the content license suspension request, the delivery control unit 23 of content delivery server 2 instructs the database control unit 41 of license server 4 to execute the following process. The procedure of this process is as follows.

Specifically, the database control unit 41 updates the date/time in the expiration date/time area 314 of the content license information 31 with the current date/time. This content license information 31 is obtained by a search using the user ID and content ID as a key. Thus, the license database 3 is updated (step S1401), and a database update completion response is returned to the delivery control unit 23. Upon receiving the database update completion response from the database control unit 41, the delivery control unit 23 sends a content license suspension notice to the local server 6 (step S1402). Then, upon receiving the content license suspension notice from the content delivery server 2, the delivery control unit 62 of the local server 6 determines whether the user who is identified by the user ID is currently using one of the user terminals 9a and 9b and the content that is identified by the content ID is being transmitted to the terminal that is used by the user (step S140). If the content is being transmitted, the transmission is suspended (step 1404).

Subsequently, the delivery control unit 62 informs the user that the content provider has executed the content license suspension process (step S1405). Specifically, if the user is currently using the user terminal 9a or user terminal 9b, a notice is immediately issued to the currently used user terminal, and the display unit 93 of the user terminal in use (e.g. user terminal 9a) is caused to display a message to the effect that the content provider has executed the content license suspension process. If the user is using neither the user terminal 9a nor user terminal 9b, such a notice is stored in the storage device 7 until one of the user terminals is used next time. When the user terminal is used next time, the notice that is stored in the storage device 7 is retrieved and sent to the user terminal in use. The display unit 93 of the user terminal in use is caused to display a message to the effect that the content provider has executed the content license suspension process. The system operation at the time the content provider suspends the content license is thus completed.

As has been described above, according to the embodiment of the invention, the content key Kc is always kept in the encrypted state on the outside of the module 64 with the anti-tampering function in the local server 6, as well as on the inside of the storage device 7. The decryption key for decrypting the encrypted content key Kc, which has been changed at the time of content reproduction, is made unavailable until next-time reproduction. When content is to be delivered from the local server 6 to the user terminal 9a, the copy protect process is executed to prevent content copy to the user terminal. It is thus possible to prevent unlawful use of content, in particular, in the state in which the content license is absent. In addition, the re-encryption process for the content key Kc is executed only at the time of content reproduction, and the number of times of execution of the re-encryption process can be reduced. Furthermore, in the embodiment of the present invention, the content license can easily be suspended from both the user side and the content provider side.

### Second Embodiment

A second embodiment of the present invention will now be described with reference to the accompanying drawings. The second embodiment differs from the first embodiment in that a time period in which a content license can be suspended by a user can be set. The configuration of the content delivery system according to the second embodiment is the same as that of the content delivery system shown in FIGS. 1 to 5, except for the content license information 31. The common parts are denoted by like reference numerals, and a detailed description thereof is omitted.

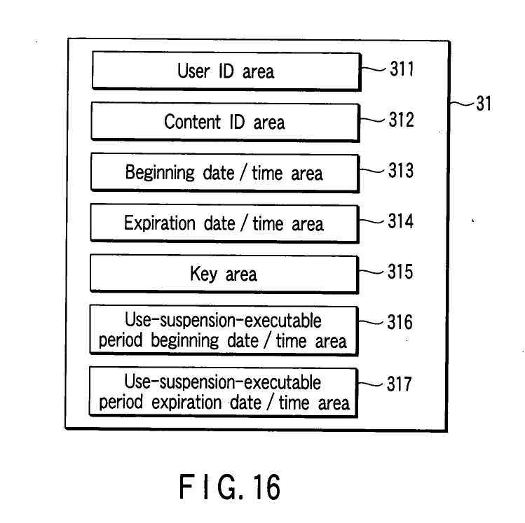

FIG. 16 shows the structure of the content license information according to the second embodiment of the invention. The content license information 31, like the structure shown in FIG. 3, includes the user ID area 311, content ID area 312, beginning date/time area 313, expiration date/time area 314, and key area 315. Additionally, the content license information 31 includes a use-suspension-executable period beginning date/time area 316 that stores a date/time at which content license suspension by the user is enabled, and a use-suspension-executable period expiration date/time area 317 that stores a date/time at which content license suspension by the user is disabled. The information that is stored in the user ID area 311, content ID area 312, beginning date/time area 313, expiration date/time area 314, and key area 315 is common in the first and second embodiments. It is preferable that the value that is to be stored in the use-suspension-executable period beginning date/time area 316 be the same as the value that is to be stored in the beginning date/time area 313.

The operation of the content delivery system, to which the content deliver apparatus according to the second embodiment of the invention is applied, will now be described. Like the first embodiment, in the second embodiment, the content reproduction, the content license suspension by the user, and the content license suspension by the content provider can be executed. Of these operations, the content reproduction and the content license suspension by the content provider are the same as those in the first embodiment, and a description is omitted.

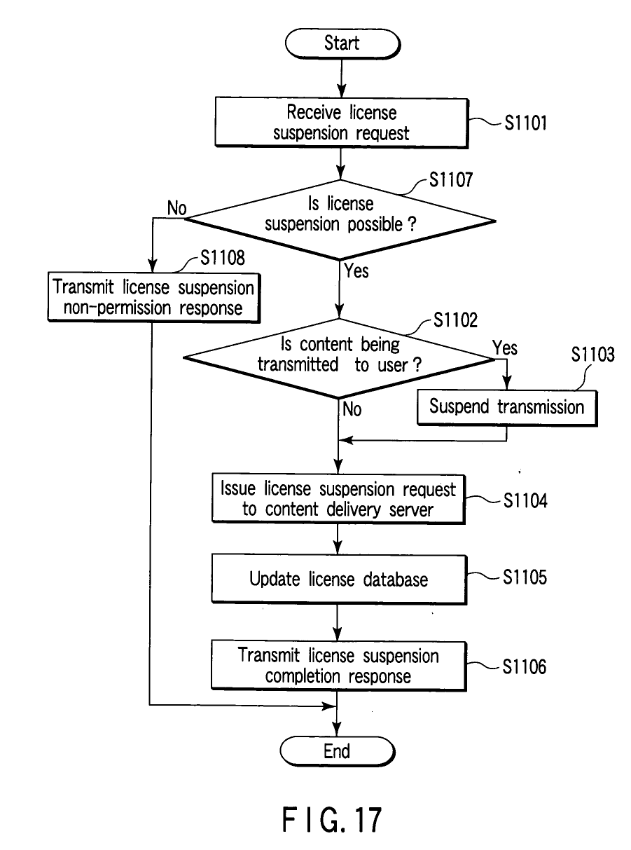

A description is thus given of the difference between the second embodiment and the first embodiment, that is, the system operation in the case where the content license is suspended by the user. FIG. 17 is a flow chart that illustrates the content license suspension process, which is executed by the user according to the second embodiment of the invention. The second embodiment differs from the first embodiment in that steps S1107 and S1108 are added.

To start with, the input unit 94 of the user terminal 9a issues a content license suspension request to the local server 6 (step S1101). The content license suspension request is accompanied with a content ID for identifying content, the license of which is to be suspended. Upon receiving the content license suspension request from the user terminal 9a, the delivery control unit 62 of the local server 6 sends to the content delivery server 2 a request for confirming permission/non-permission of content license suspension by the user. Upon receiving the request for confirming permission/non-permission of content license suspension, the delivery control unit 23 of the content delivery server 2 searches the license database 3 via the database control unit 41 of license server 4 using, as a key, the pair of the user ID for identifying the user (the user ID being retained by the delivery control unit 23 at the time of user authentication) and the content ID. Thus, the delivery control unit 23 acquires the content license information 31 corresponding to the key. Using the value stored in the use-suspension-executable period beginning date/time area 316 and the value stored in the use-suspension-executable period expiration date/time area 317, the delivery control unit 23 determines whether the content license suspension by the user is possible or not. The method of the determination is the same as in the case of the above-described content reproduction (step S1107). If the license suspension is possible, the delivery control unit 23 sends a license suspension permission response to the local server 6. If the license suspension is impossible, the delivery control unit 23 sends a license suspension non-permission response to the local server 6. If the delivery control unit 62 of local server 6 receives the license suspension permission response from the content delivery server 2, control advances to step S1102. The subsequent steps are the same as those in the first embodiment, and a description is omitted here.

If the delivery control unit 62 of local server 6 receives the license suspension non-permission response from the content delivery server 2, the delivery control unit 62 sends a content license suspension non-permission response to the user terminal 9a. Upon receiving the content license suspension non-permission response, the user terminal 9a causes the display unit 93 to display a message to the effect that the content license suspension procedure is rejected by the content delivery server, and informs the user that the procedure has failed to be executed. The system operation at the time of the content license suspension by the user is thus completed.

As has been described above, in the second embodiment of the invention, the time period in which the content license suspension by the user is enabled can be set.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A content delivery system comprising:
first encryption means for generating a content key for encrypting selected content to generate encrypted content, and decrypting the encrypted content;
second encryption means for generating a first encryption key for encrypting the content key to generate an encrypted content key;
first delivery means for delivering via a network the encrypted content that is encrypted by the first encryption means and the encrypted content key that is encrypted by the second encryption means;
storage means for storing the encrypted content and the encrypted content key that are delivered by the first delivery means;
second delivery means for generating, upon receiving a reproduction request for reproducing predetermined content, a first decryption key for decrypting the encrypted content key corresponding to the predetermined content, the reproduction request for which is received, and a second encryption key for re-encrypting the decrypted content key that is decrypted by the first decryption key, and delivering the first decryption key and the second encryption key via the network;
first decryption means for decrypting the encrypted content key using the first decryption key that is delivered by the second delivery means;
second decryption means for decrypting the encrypted content using the decrypted content key that is decrypted by the first decryption means;
re-encryption means for re-encrypting, with use of the second encryption key, the decrypted content key that is decrypted by the first decryption means; and
updating means for updating the encrypted content key that is stored in the storage means with the encrypted content key that is re-encrypted by the re-encryption means, and storing the updated encrypted content key in the storage means.

2. A content delivery system including a license server that manages license information on stored content, and a content delivery server that is connected to the license server and a network and delivers the license information and the stored content to a local server via the network,
the content delivery server comprising:
first encryption means for generating a content key for encrypting selected content to generate encrypted content, and decrypting the encrypted content;
second encryption means for encrypting the content key, thereby generating an encrypted content key;
first delivery means for delivering via the network the encrypted content that is encrypted by the first encryption means and the encrypted content key that is encrypted by the second encryption means; and
second delivery means for generating, upon receiving a reproduction request for reproducing predetermined content, a first decryption key for decrypting the encrypted content key corresponding to the predetermined content, the reproduction request for which is received, and a second encryption key for re-encrypting the decrypted content key that is decrypted by the first decryption key, and delivering the first decryption key and the second encryption key via the network,
the license server comprising:
first generation means for generating a first encryption key, with which the second encryption means generates the encrypted content key; and
second generation means for generating a first decryption key for decrypting the encrypted content key corresponding to the predetermined content, the reproduction request for which is received, and a second encryption key for re-encrypting the decrypted content key that is decrypted by the first decryption key, and
the local server comprising:
storage means for storing the encrypted content and the encrypted content key that are delivered by the first delivery means;
first decryption means for decrypting the encrypted content key using the first decryption key that is delivered by the second delivery means;
second decryption means for decrypting the encrypted content using the decrypted content key that is decrypted by the first decryption means;
re-encryption means for re-encrypting, with use of the second encryption key, the decrypted content key that is decrypted by the first decryption means; and
updating means for updating the encrypted content key that is stored in the storage means with the encrypted content key that is re-encrypted by the re-encryption means, and storing the updated encrypted content key in the storage means.

3. A content receiving/storing apparatus that receives and stores encrypted content via a network,
wherein each time the encrypted content is to be decrypted, request information for requesting an encrypted content key for decrypting the encrypted content is transmitted, and the encrypted content key corresponding to the request information is received and used for the decryption of the encrypted content.

4. A content receiving/storing apparatus that receives and stores encrypted content via a network, comprising:
first receiving means for receiving, via a network, encrypted content and an encrypted content key, the encrypted content being generated by encrypting selected content using a content key, the content key being used for encrypting the selected content to generate the encrypted content and decrypting the encrypted content, the encrypted content key being generated using a first encryption key for encrypting the content key;
storage means for storing the encrypted content and the encrypted content key that are received by the first receiving means;
second receiving means for receiving, via the network, a first decryption key for decrypting the encrypted content key corresponding to a reproduction request for reproducing predetermined content, and a second encryption key for re-encrypting the decrypted content key that is decrypted by the first decryption key;
first decryption means for decrypting the encrypted content key using the first decryption key that is received by the second receiving means;
second decryption means for decrypting the encrypted content using the decrypted content key that is decrypted by the first decryption means;
re-encryption means for re-encrypting, with use of the second encryption key, the decrypted content key that is decrypted by the first decryption means; and
updating means for updating the encrypted content key that is stored in the storage means with the encrypted content key that is re-encrypted by the re-encryption means, and storing the updated encrypted content key in the storage means.
